(19) United States
(12) Patent Application Publication
(10) Pub. No.: US 2015/0235755 A1
(43) Pub. Date: Aug. 20, 2015

(54) PLANAR COIL AND MANUFACTURING METHOD FOR TRANSFORMER AND PLANAR COIL

(71) Applicant: KABUSHIKI KAISHA TOYOTA JIDOSHOKKI, Aichi (JP)

(72) Inventors: Kiminori Ozaki, Kariya-shi (JP); Yasuhiro Koike, Kariya-shi (JP); Hiroaki Asano, Kariya-shi (JP); Hitoshi Shimazu, Kariya-shi (JP); Tomoaki Asai, Nagoya-shi (JP)

(73) Assignee: KABUSHIKI KAISHA TOYOTA JIDOSHOKKI, Aichi (JP)

(21) Appl. No.: 14/428,481

(22) PCT Filed: Sep. 12, 2013
(86) PCT No.: PCT/JP2013/074713

§ 371 Date: Mar. 16, 2015

(30) Foreign Application Priority Data
Sep. 20, 2012 (JP) 2012-207387

(51) Int. Cl. H01F 27/28; H01F 41/04

(52) U.S. Cl. CPC H01F 27/2804; H01F 27/2876; H01F 41/045; H01F 2027/2819

(57) ABSTRACT

A planar coil includes an effective line segment, which extends over at least one turn and is configured such that a current flows therein, and a dummy line segment, which extends over at least one turn and is configured such that a current does not flow therein.

### TECHNICAL FIELD

The present disclosure relates to a planar coil, a transformer, and a method for manufacturing a planar coil.

### BACKGROUND ART

Patent Document 1 discloses a method for manufacturing a coil component that includes a magnetic substrate, a plastic layer formed on the magnetic substrate, and a planar coil conductor embedded in the plastic layer. The manufacturing process includes a step of preparing a magnetic substrate, a step of forming a plastic layer on the magnetic substrate, a step of forming a coil-shaped groove by pressing a die having a coil-shaped projection against the plastic layer, and a step of forming a planar coil conductor by filling the groove with a conductive metal.

### PRIOR ART DOCUMENT

### Patent Document

Patent Document 1: Japanese Laid-Open Patent Publication No. 2010-87030

### SUMMARY OF THE INVENTION

### Problems that the Invention is to Solve

In the method for manufacturing a coil component described above, a change in the number of turns of the planar coil conductor requires a new die, which results in high costs. Further, the time required for manufacturing a new die inhibits a prompt change of the number of turns.

It is an objective of the present disclosure to provide a planar coil, a transformer, and a method for manufacturing a planar coil that have a high flexibility in the number of turns.

### Means for Solving the Problems

To achieve the foregoing objective, a planar coil is provided that includes a an effective line segment that extends over at least one turn and is configured to carry a current and a dummy line segment that extends over at least one turn and is configured not to carry a current.

### BRIEF DESCRIPTION OF THE DRAWINGS

FIG. 1A is a plan view showing a planar coil of a first embodiment;

FIG. 1B is a front view showing the planar coil of FIG. 1A;

FIG. 2A is an enlarged view of section II in FIG. 1A;

FIG. 2B is a vertical cross-sectional view taken along line 2B-2B in FIG. 2A;

FIG. 2C is a vertical cross-sectional view taken along line 2C-2C in FIG. 2A;

FIG. 3A is a plan view showing a planar coil;

FIG. 3B is a front view showing the planar coil of FIG. 3A;

FIG. 4 is an enlarged view showing section IV in FIG. 3A;

FIG. 5A is a plan view showing a planar coil;

FIG. 5B is a front view showing the planar coil of FIG. 5A;

FIG. 6A is an enlarged view showing VI section in FIG. 5A;

FIG. 6B is a vertical cross-sectional view taken along line 6B-6B in FIG. 6A;

FIG. 6C is a vertical cross-sectional view taken along line 6C-6C in FIG. 6A;

FIG. 7A is a plan view showing a transformer of a second embodiment;

FIG. 7B is a vertical cross-sectional view taken along line 7B-7B in FIG. 7A;

FIG. 7C is a vertical cross-sectional view taken along line 7C-7C in FIG. 7A;

FIG. 8A is a plan view showing a transformer;

FIG. 8B is a vertical cross-sectional view taken along line 8B-8B in FIG. 8A; and

FIG. 8C is a vertical cross-sectional view taken along line 8C-8C in FIG. 8A.

### MODES FOR CARRYING OUT THE INVENTION

### First Embodiment

A planar coil according to one embodiment will now be described with reference to the drawings.

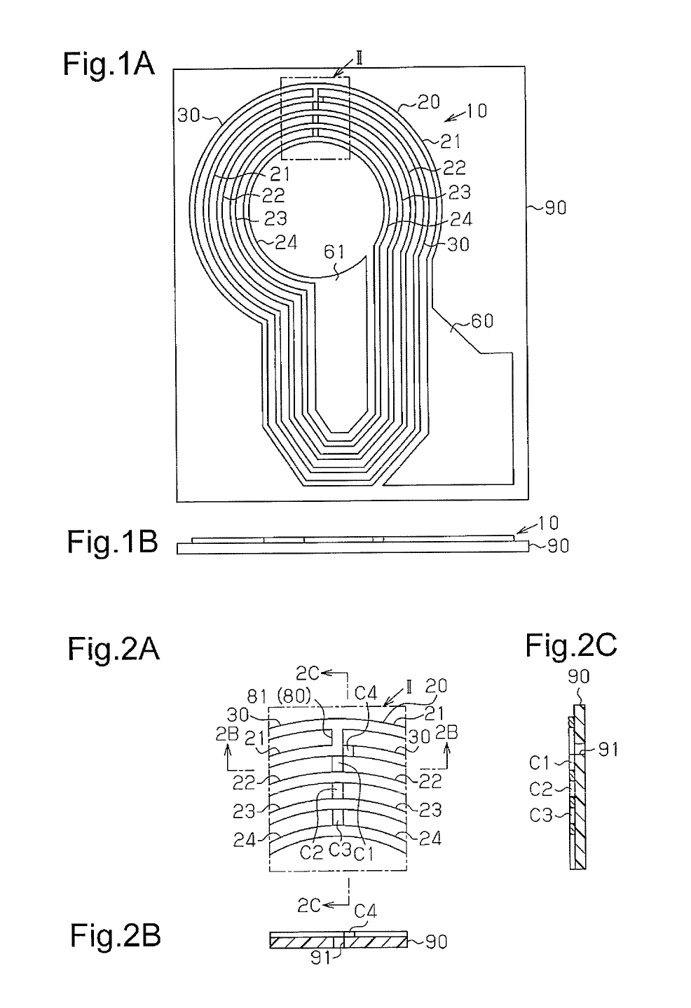

Referring to FIG. 1A, a planar coil 10 is formed by stamping a metal plate, such as a copper plate, with a press. The planar coil 10 is bonded to the upper surface of a substrate 90 by an adhesive sheet, for example. The number of the turns of the planar coil 10 is four. The planar coil 10 includes a winding section 20, a wide terminal section 60 arranged at one end of the winding section 20, and a wide terminal section 61 arranged at the other end of the winding section 20. The winding section 20 is wound into a spiral.

A line segment 30 that is the outermost turn of the winding section 20 functions as a dummy line segment 30, which does not carry a current. Line segments 21, 22, 23 and 24, which are four turns on the inner side of the dummy line segment 30, function as effective line segments that carry a current. The number of turns of the planar coil 10, which is four as mentioned above, refers to the number of turns of the effective winding 21 to 24, that is, the number of effective turns of the planar coil 10.

As shown in FIGS. 2A and 2B, a cut out section C4 is formed by cutting out a section of the second outermost line segment. A connection section 81, which is adjacent to the cut out section C4, connects the outermost line segment and the second outermost line segment.

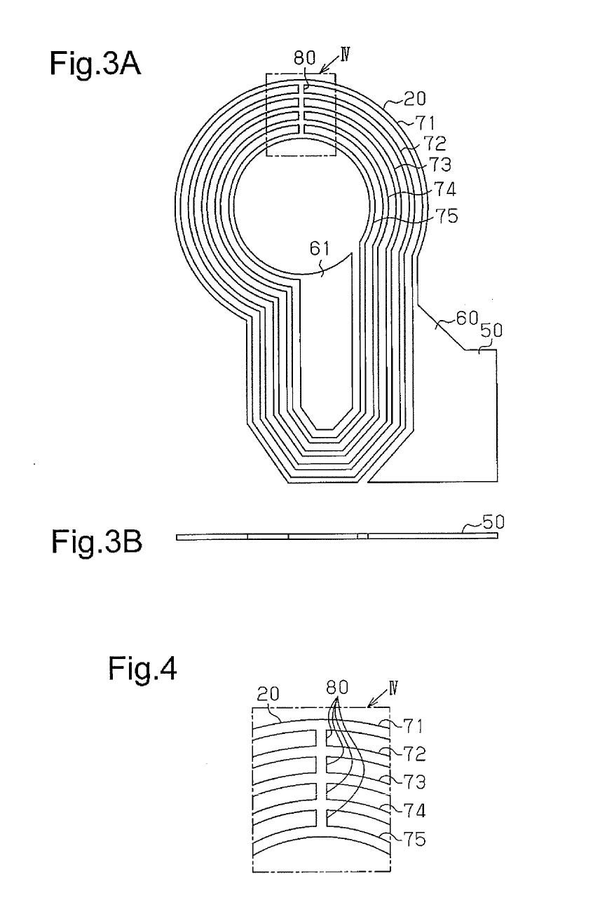

More specifically, referring to FIG. 3A, when the winding section 20 having a coil shape, in other words, including five turns of line segments 71, 72, 73, 74 and 75, is formed by stamping a metal plate 50 with a stamping die, the spiral winding section 20 includes a connection section 80 that extends in the radial direction as shown in FIG. 4. After the metal plate 50 is bonded to the plastic substrate 90, a section of the second outermost line segment is cut out by stamping to form the cut out section C4 as shown in FIGS. 2A and 2B. In addition, a cut out section C1 is formed by cutting out the section of the connection section 80, which extends in the radial direction, between the second outermost line segment and the third outermost line segment. A cut out section C2 is formed by cutting out the section of the connection section 80, which extends in the radial direction, between the third outermost line segment and the fourth outermost line segment. A cut out section C3 is formed by cutting out the section of the connection section 80, which extends in the radial direction, between the fourth outermost line segment and the fifth outermost line segment.

Accordingly, the effective line segments 21, 22, 23 and 24 are connected to the dummy line segment 30 at one section (connection section 81) and are separated from the dummy line segment 30 at another section (cut out sections C1, C2, C3 and C4). Thus, at least one turn is an effective line segment, and at least one turn is a dummy line segment. This allows for a high flexibility in the number of turns.

The planar coil 10 (the effective line segments and the dummy line segment) is bonded to the plastic substrate 90, which functions as an insulation substrate.

Next, operation of the planar coil 10 will now be described.

In manufacturing, as shown in FIGS. 3A and 4A, the spiral winding section 20 and the connection section 80, which connects the turns of the winding section 20 in the radial direction, are formed by stamping the metal plate 50 with a stamping die. The connection section 80 maintains the clearance between the line segments of the winding section 20. The connection section 80 is part of the metal plate 50 that is stamped out.

Then, the stamped metal plate 50 (planar coil 10) is bonded to one surface of the plastic substrate 90. The plastic substrate 90 includes through holes 91. The through holes 91 are formed in regions that correspond to the cut out sections C1, C2, C3 and C4. That is, the through holes 91 are formed in regions that correspond to the sections of the metal plate 50 that are to be cut out by a stamping die.

Next, the substrate 90 and the metal plate 50, which is bonded to the substrate 90, are placed in a press. The unnecessary sections are stamped out from the metal plate 50 with a stamping die to form the effective line segments and the dummy line segment. In other words, the unnecessary sections of the metal plate 50 are removed to cut the connection section 80 of the planar coil by stamping the metal plate 50 bonded to the plastic substrate 90. This insulates the turns of the winding section 20 from one another in the radial direction. The winding section 20 that includes four turns of effective line segments as shown in FIGS. 1A and 2A is formed from the metal plate 50 shown in FIG. 3A. Specifically, the cut out section C4 is formed in the second outermost line segment, and the cut out sections C1, C2 and C3 are formed in the connection section 80 that extends in the radial direction.

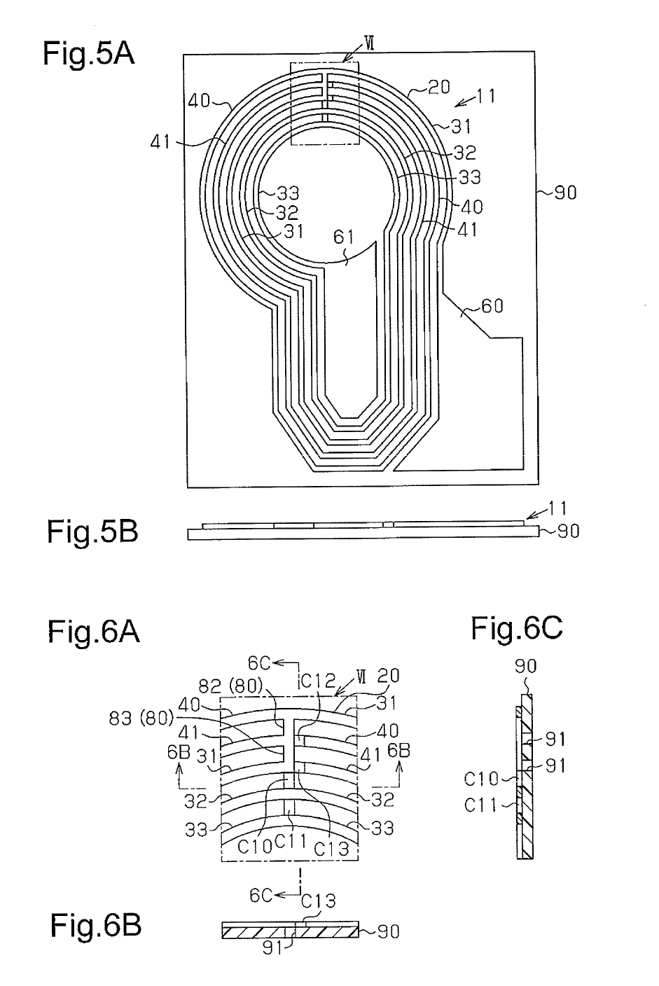

Alternatively, a planar coil 11 shown in FIGS. 5A and 6A is formed from the metal plate 50 of FIG. 3A that includes five turns of line segments. The planar coil 11 includes a winding section 20 that includes three turns of effective line segments. Specifically, the metal plate 50 shown in FIG. 3A, which is bonded to the plastic substrate 90, is stamped to form a cut out section C12 in the second outermost line segment and to form a cut out section C13 in the third outermost line segment as shown in FIG. 6. In addition, a cut out section C10 is formed by cutting out the section of the connection section 80, which extends in the radial direction, between the third outermost line segment and the fourth outermost line segment. Further, a cut out section C11 is formed by cutting out the section of the connection section 80 between the fourth outermost line segment and the fifth outermost line segment. Thus, in the winding section 20 of the planar coil 11, a line segment 40 of the outermost turn and a line segment 41 of the second outermost turn function as dummy line segments, which do not carry a current. Line segments 31, 32 and 33 of three turns on the inner side of the dummy line segment 41 function as an effective winding, which carries a current.

Accordingly, the number of turns (effective turns) of the winding section 20 can be easily changed by changing the cut out positions (insulation positions) of the connection section.

The above described embodiment has the following advantages.

(1) The planar coil 10 includes at least one turn of an effective line segment that carry a current and at least one turn of dummy line segment that does not carry a current. This allows for a high flexibility in the number of turns.

In the present embodiment, the number of turns can be easily changed by changing the cut out positions (insulation positions) of the connection section as shown in FIGS. 2A and 6A. This reduces the costs. In addition, change in the number of turns involves only the manufacturing of a die that cuts the connection section. This enables a prompt change of the number of turns.

(2) The effective line segment and the dummy line segment are connected to each other at one section and separated from each other at another section. In other words, the dummy line segment includes a first end that is connected to the effective line segment and a second end that is separated from the effective line segment. Thus, the planar coil 10 includes at least one turn of effective line segment and at least one turn of dummy line segment.

(3) The effective line segment and the dummy line segment are bonded to one surface of the plastic substrate 90. The presence of the dummy line segment in the metal plate 50 allows for a firm bonding of the metal plate 50 to the substrate 90.

(4) The method for manufacturing a planar coil includes the first to third steps. In the first step, the spiral winding section 20 and the connection section 80, which connects the turns of the winding section 20 in the radial direction, are formed by stamping the metal plate 50. In the second step, the metal plate 50, which has been stamped out in the first step, is bonded to the substrate 90. In the third step, the unnecessary sections of the metal plate 50, which is bonded to the substrate 90 in the second step, are stamped out to form the effective line segment, which extends over at least one turn and carries a current, and the dummy line segment, which extends over at least one turn and does not carry a current. Thus, various types of planar coils can be manufactured in single equipment (one press) just by changing cut out sections.

### Second Embodiment

A second embodiment will now be described. The differences from the first embodiment will be mainly discussed.

The present embodiment is a transformer that includes a primary winding, a secondary winding, and a core.

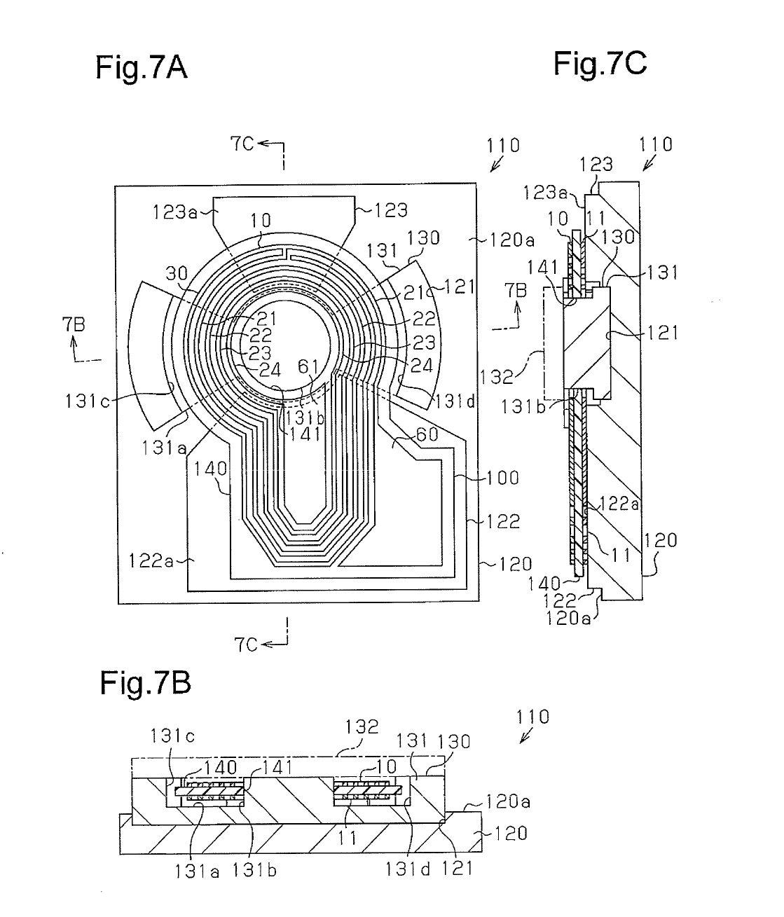

As shown in FIGS. 7A to 7C, the planar coil 10 (effective line segments and dummy line segment) shown in FIG.

1A is bonded to the upper surface of an insulation substrate 140. The planar coil 11 shown in FIG. 5A is bounded to the lower surface of the insulation substrate 140 as a conductive line. The planar coil 11, which functions as a conductive line, is symmetrical to the planar coil 10 with respect to the insulation substrate 140, that is, the planar coil 11 is arranged to face the planar coil 10 with the insulation substrate 140 sandwiched between the planar coils 10 and 11. The planar coil 10 (effective line segment) forms the primary winding of the transformer, and the planar coil 11 (conductive line) forms the secondary winding of the transformer. The insulation substrate 140 and the two planar coils 10 and 11 arranged on the opposite sides of the insulation substrate 140 form the transformer, which is a planar coil assembly.

A case 120, which functions as a heat dissipation member, is thermally coupled to the planar coil 11.

The details are given below.

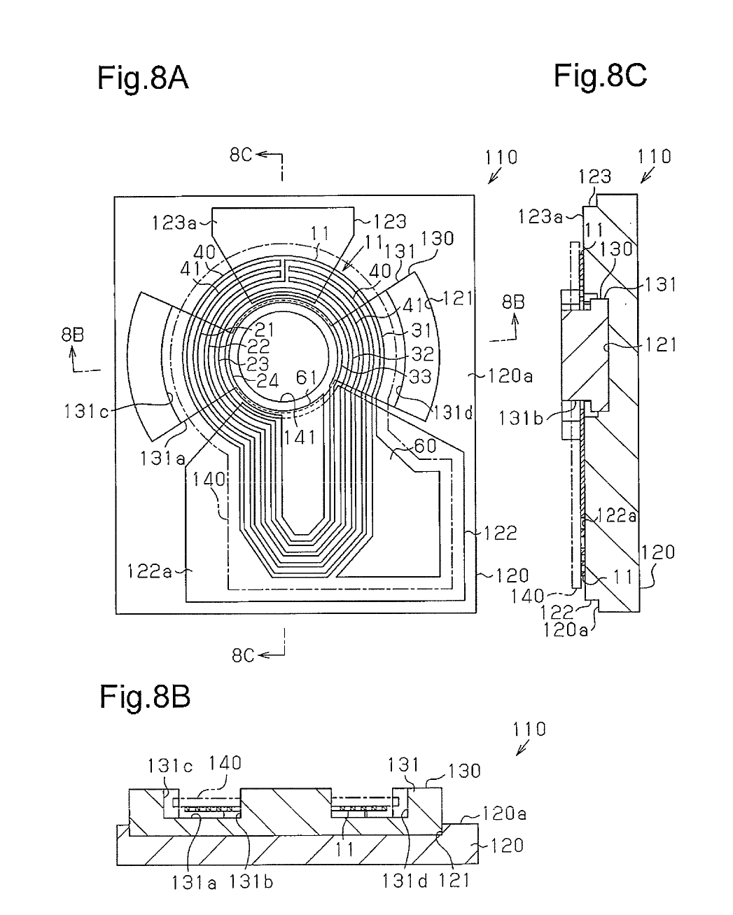

As shown in FIGS. 7A to 8C, a transformer 110 is structured such that the heat generated in the winding section of the transformer 110 dissipates through the case 120.

An E-I core is used as a core 130. The core 130 includes an E core 131 and an I core 132. FIG. 7C indicates the I core 132 by the long dashed short dashed line.

The planar coil 10, which functions as the primary winding, is bonded to the upper surface, which is the first surface, of the insulation substrate 140. The planar coil 11, which functions as the secondary winding, is bonded to the lower surface, which is the second surface opposite to the first surface, of the insulation substrate 140. FIG. 8C does not show the I core 132 or the planar coil 10 of FIG. 7C and indicates the insulation substrate 140 by the long dashed short dashed line.

The planar case 120 has an upper surface 120a that includes a recess 121. The E core 131 is fitted into the recess 121 of the case 120. The E core 131 includes a planar main body portion 131a, a central magnetic leg 131b projecting from the central section of the upper surface of the main body portion 131a, and two side magnetic legs 131c and 131d projecting from the end sections of the upper surface of the main body portion 131a. The central magnetic leg 131b is cylindrical.

As shown in FIGS. 8A and 8C, mount portions 122 and 123 are arranged on the upper surface 120a of the case 120 and sandwich the central magnetic leg 131b of the E core 131. The upper surface 122a of the mount portion 122 and the upper surface 123a of the mount portion 123 are flat and equal in height.

The planar coil 11 is placed over the upper surfaces 122a and 123a of the mount portions 122 and 123 of the case 120. A silicon sheet (not shown) is sandwiched between the upper surfaces 122a and 123a and the planar coil 11. The mount portions 122 and 123 of the case 120 absorb the heat generated in the planar coils 10 and 11.

As shown in FIGS. 7A to 7C, the central section of the insulation substrate 140 includes a through hole 141, through which the central magnetic leg 131b of the E core 131 extends. As shown in FIG. 7A, the winding section of the planar coil 10 is a single conductor that is wound about the through hole 141 of the insulation substrate 140 and includes four turns of effective line segments and one turn of dummy line segment. As shown in FIG. 8A, the winding section of the planar coil 11 is a single conductor that is wound about the through hole 141 of the insulation substrate 140 and includes three turns of effective line segments and two turns of dummy line segments.

The planar coil 11 is bonded to the upper surfaces 122a and 123a of the mount portions 122 and 123 of the case 120 such that the planar coil 11 is insulated from the upper surfaces 122a and 123a. This limits increase in the temperature of the winding section of the transformer.

In addition to the advantages (1) to (4), the present embodiment achieves the following advantages.

(5) The planar coil 11 is formed on the second surface (lower surface) of the insulation substrate 140. This allows the transformer to be thin, which is desirable in use.

(6) The planar coil 11 has a spiral shape and is symmetrical to the planar coil 10 with respect to the insulation substrate 140. That is, the planar coil 11 faces the planar coil 10 with the insulation substrate 140 sandwiched between the planar coils 10 and 11. This strengthens the bonding of the planar coil 10 and the planar coil 11 to the insulation substrate 1 when press bonding the planar coil 10 and the planar coil 11 to the insulation substrate 140 from the upper and lower sides of the insulation substrate 140.

(7) The effective line segments of the planar coil 10 function as the primary winding of the transformer. The planar coil 11 functions as the secondary winding of the transformer. This facilitates the formation of the transformer 110.

(8) The case 120, which functions as a heat dissipation member, is thermally coupled to the planar coil 11. This forms a heat transfer path including the dummy line segment, thereby increasing the heat dissipation efficiency.

The present disclosure is not limited to the above described embodiments, but may be embodied as follows, for example.

In the second embodiment, the planar coil 10 is bonded to the upper surface of the insulation substrate 140, and the planar coil 11 is bonded to the lower surface of the insulation substrate 140. However, the present disclosure is not limited to such a structure. For example, the planar coil 10 may be bonded to the lower surface of the insulation substrate 140, and the planar coil 11 may be bonded to the upper surface of the insulation substrate 140.

Further, the planar coil 10 arranged on the upper surface of the insulation substrate 140 may be thermally coupled to a heat dissipation member. Alternatively, both of the planar coil 10 and the planar coil 11 may be thermally coupled to a heat dissipation member.

As long as at least one of the planar coil 10 and the planar coil 11 is thermally coupled to a heat dissipation member, a heat transfer path that includes the dummy line segment is formed. This increases the heat dissipation efficiency.

The planar coils 10 and 11 may be formed from aluminum plates. In short, the planar coils 10 and 11 may be formed from any conductive metal.

The winding may have any number of turns as long as at least one turn is an effective line segment and at least one turn is a dummy line segment.

Instead of bonding the planar coils with adhesive, the planar coils may be joined to the substrate through other methods.

1-10. (canceled)

11. A planar coil intermediate body comprising:
a metal plate including a spiral winding section, which includes a plurality of turns, and a connection section, which connects all of the turns in a radial direction; and
an insulation substrate including a first surface to which the metal plate is bonded or joined.

12. The planar coil intermediate body according to claim 11, wherein the insulation substrate includes a second surface on which a conductive line is located.

13. The planar coil intermediate body according to claim 12, wherein the conductive line has a spiral shape and is symmetrical to the turns of the winding section with respect to the insulation substrate.

14. The planar coil intermediate body according to claim 13, wherein a part of the turns of the winding section forms a primary winding of a transformer, and the conductive line forms a secondary winding of the transformer.

15. The planar coil intermediate body according to claim 14, wherein a heat dissipation member is thermally coupled to at least one of the metal plate and the conductive line.

16. A method for manufacturing a planar coil, the method comprising:
a first step of forming, by stamping a metal plate, a spiral winding section and a connection section, which connects turns of the winding section in a radial direction;
a second step of bonding the metal plate that is stamped out in the first step to a substrate; and
a third step of stamping out an unnecessary section of the metal plate that is bonded to the substrate in the second step to form an effective line segment, which extends over at least one turn and is configured to carry a current, and a dummy line segment, which extends over at least one turn and is configured not to carry a current.
